(19) United States
(12) Patent Application Publication
(10) Pub. No.: US 2007/0005254 A1
(43) Pub. Date: Jan. 4, 2007

(54) Methods and apparatuses for processing biological data

(76) Inventors: Erik Jonathan Nilsson, Seattle, WA (US); Brian Stephens Pratt, Seattle, WA (US)

Correspondence Address: PELOQUIN, PLLC, 800 FIFTH AVENUE, SUITE 4100, SEATTLE, WA, 98104-3100, US

(21) Appl. No.: 10/574,382

(22) PCT Filed: Apr. 2, 2005
(86) PCT No.: PCT/US05/11351

§ 371 Date: Mar. 31, 2006

(30) Foreign Application Priority Data
Apr. 2, 2004 (US) 60559366

(51) Int. Cl. G06F 19/00

(52) U.S. Cl. 702/19

(57) ABSTRACT

Methods and apparatuses are described to process an n-dimensional data set acquired from a measurement on a biological sample. A method includes dividing an n-dimensional data set into n-dimensional sub-regions, wherein a size of a dimension of an n-dimensional sub-region is less than a size of the dimension of the n-dimensional data set. The n-dimensional sub-regions are stored on a computer readable medium and the computer readable medium is accessible to a data processing system. The n-dimensional data set can exceed an addressable memory limit of the data processing system and mathematical operations are performed on the n-dimensional data set.

### CROSS-REFERENCES TO RELATED APPLICATIONS

This patent application is related to and claims priority from U.S. Provisional Patent Application, Ser. No. 10/559,366, filed on Apr. 2, 2004, entitled “Methods And Apparatuses For Processing Biological Data.”

U.S. Provisional Patent Application, Ser. No. 10/559,366, filed on Apr. 2, 2004, entitled “Methods And Apparatuses For Processing Biological Data,” is hereby incorporated by reference into the present application.

### BACKGROUND OF THE INVENTION

1. Field of Invention

Embodiments of the invention relate generally to biological sample data, and more specifically to apparatuses and methods used to process biological sample data for pattern recognition.

2. Art Background

Various techniques have been developed for the analysis of biological samples. Some of the techniques include Liquid Chromatography (LC), Gas Chromatography (GC), Mass Spectrometry, Multidimensional Protein Identification Technology (MudPIT), etc. Analysis of biological samples utilizing these techniques and others has resulted in the combination or hyphenation of techniques, such as combining multiple stages of Gas Chromatography (GC) in series with one or more stages of Mass Spectrometry.

Such combination or hyphenation of techniques allows multidimensional biological data to be collected. Hyphenation of techniques permits a researcher to extract an increased amount of information from a biological sample and is therefore a desirable exercise to undertake. Collection of data from such instrumentation is commonly done with the aid of a computerized data acquisition system, where a property of a biological sample, such as atomic mass is measured as a function of time. Hyphenation of analysis techniques leads to the creation of multidimensional data files that exceed the size of addressable memory of existing computers. Such limitations of existing computers render large biological data files unreadable and/or unprocessable when mathematical operations are attempted with the entire data set. This presents a problem.

Data compression is sometimes attempted in an effort to reduce the size of large biological data sets to manageable size. One method of data compression is to employ peak-finding, however, peak-finding inevitably introduces biases into the data; either very small peaks must be thrown away or else phantom peaks will occasionally be created. Both of these problems introduce unwanted artifacts into the data, presenting problems thereby. Supervised peak-finding techniques build a model based on a training set. If a biological data set contains a peak that was not in the training set a problem is created: either the peak must be ignored or else the training set must be recalculated, potentially invalidating earlier results.

### BRIEF DESCRIPTION OF THE DRAWINGS

The invention may best be understood by referring to the following description and accompanying drawings that are used to illustrate embodiments of the invention. The invention is illustrated by way of example in the embodiments and is not limited in the figures of the accompanying drawings, in which like references indicate similar elements.

FIG. 1 illustrates a two-dimensional gas chromatograph, according to one embodiment of the invention.

FIG. 2A illustrates processing hyphenated separations data according to one embodiment of the invention.

FIG. 2B illustrates a process for creating an n-dimensional data set from a biological sample.

FIG. 3 illustrates visualization of two-dimensional separations data according to one embodiment of the invention.

FIG. 4 shows one embodiment of a multidimensional separations system hyphenated with a mass spectrometer according to one embodiment of the invention.

FIG. 5 illustrates a general multidimensional biological sample measurement system according to one embodiment of the invention.

FIG. 6 illustrates an array of biological data according to one embodiment of the invention.

FIG. 7 depicts traditional storage of an array of biological data.

FIG. 8A shows one embodiment of a division of biological data into sub-regions (bricks).

FIG. 8B illustrates a process for dividing an n-dimensional data set into n-dimensional sub-regions.

FIG. 9 illustrates one embodiment of storing sub-regions (bricks) of biological data.

FIG. 10 illustrates a memory structure applied to sub-regions (bricks) of biological data according to one embodiment of the invention.

FIG. 11 shows a relationship of meta-data and data bricks according to one embodiment of the invention.

FIG. 12A illustrates combinations of sub-region dimensions and corresponding unused storage space according to one embodiment of the invention.

FIG. 12B is a continuation of the table of FIG. 12A.

FIG. 12C is a continuation of the table of FIG. 12B.

### DETAILED DESCRIPTION

In the following detailed description of embodiments of the invention, reference is made to the accompanying drawings in which like references indicate similar elements, and in which is shown by way of illustration, specific embodiments in which the invention may be practiced. These embodiments are described in sufficient detail to enable those of skill in the art to practice the invention. In other instances, well-known circuits, structures, and techniques have not been shown in detail in order not to obscure the understanding of this description. The following detailed description is, therefore, not to be taken in a limiting sense, and the scope of the invention is defined only by the appended claims.

Apparatuses and methods are described, for processing data obtained from a complex sample, that permit multidimensional complex sample data sets to be loaded into existing computers for analysis. Techniques are described that allow multidimensional complex sample data to be stored beyond the addressable memory limit of a data processing system.

Complex samples include biological samples, complex natural samples, and process control samples. Biological samples include any sample that is part of an organism, a substance containing an organism, a fluid produced by an organism, etc. A complex natural sample is a sample from “nature,” for example any sample from the natural environmental world; geological samples, air or water samples, soil samples, etc. Process control samples are samples taken from a manufacturing process to measure quality, purity, efficiency, control of contaminants or by-products, etc.

The three types of complex samples listed above are not firm classifications and a complex sample can be in more than one of these categories. For example, a sample from a brewery operation could be both a process control sample and a biological sample. No limitation is implied within the embodiments of the present invention by the complex sample. As used within this description of embodiments of the invention, “complex samples” will be referred to as a “biological sample,” a “complex biological sample” or similar terms, no limitation is intended thereby.

Chemical analysis of complex biological samples like the proteins within an organism, often require multiple analytical techniques to be combined or hyphenated; thereby, producing a data set that is too large to be stored in the addressable memory of a data processing system. Analysis of the output of many different kinds of measurement techniques can be performed with various embodiments of the present invention. Multiple measurement techniques are combined or hyphenated to produce multidimensional biological data sets.

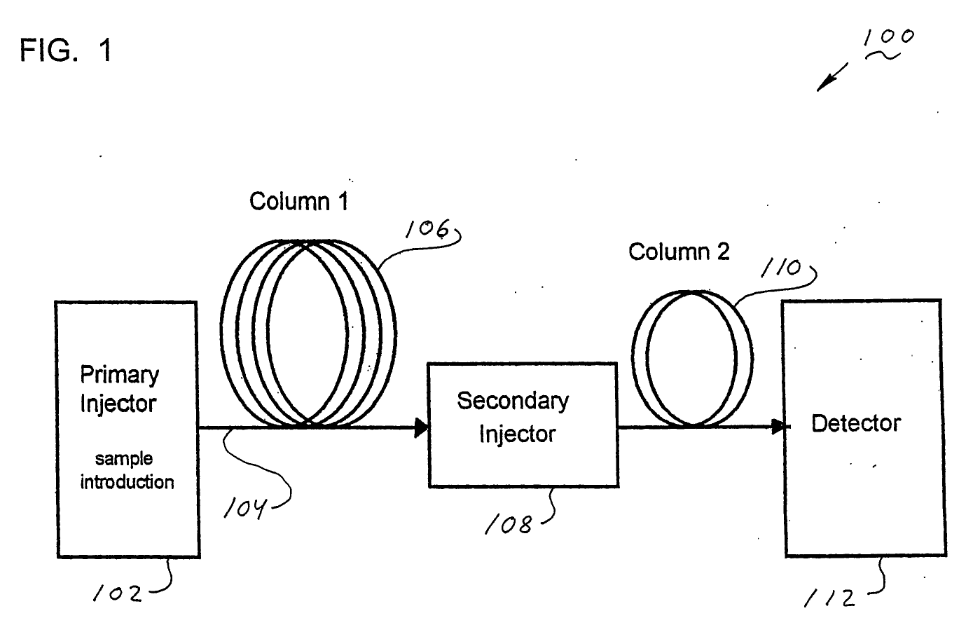

FIG. 1 illustrates generally at 100, two gas chromatography (GC) separation stages hyphenated together (GC×GC), according to one embodiment of the invention. With reference to FIG. 1, a first (GC) stage introduces a quantity of a biological sample under test via a primary injector 102 into pipe 104. The sample under test flows through the tube 104 and into the first column 106. The first column 106 is heated by an oven; the oven temperature is ramped causing more volatile substances to pass through the column more quickly than less volatile substances.

The first column 106 is connected to a secondary injector 108 which injects a quantity of the sample under test into the second column 110. The secondary injection causes another dimension of separation to occur within the sample as the sample passes through the second column 110. The frequency of the secondary injector 108 is higher than the peak widths eluting from the first column 106. In one embodiment, the first stage of separation runs for approximately one hour and the second stage of separation injects an amount of sample into the second column 110 every two (2) seconds. A property of the sample is measured at the detector 112. In one embodiment, the detector 112 measures electric current resulting from ionization of the eluting peaks utilizing a flame ionization detector. In another embodiment, a mass spectrum of eluting peaks can be detected. The present invention is not limited by the property of the biological sample measured at the detector 112.

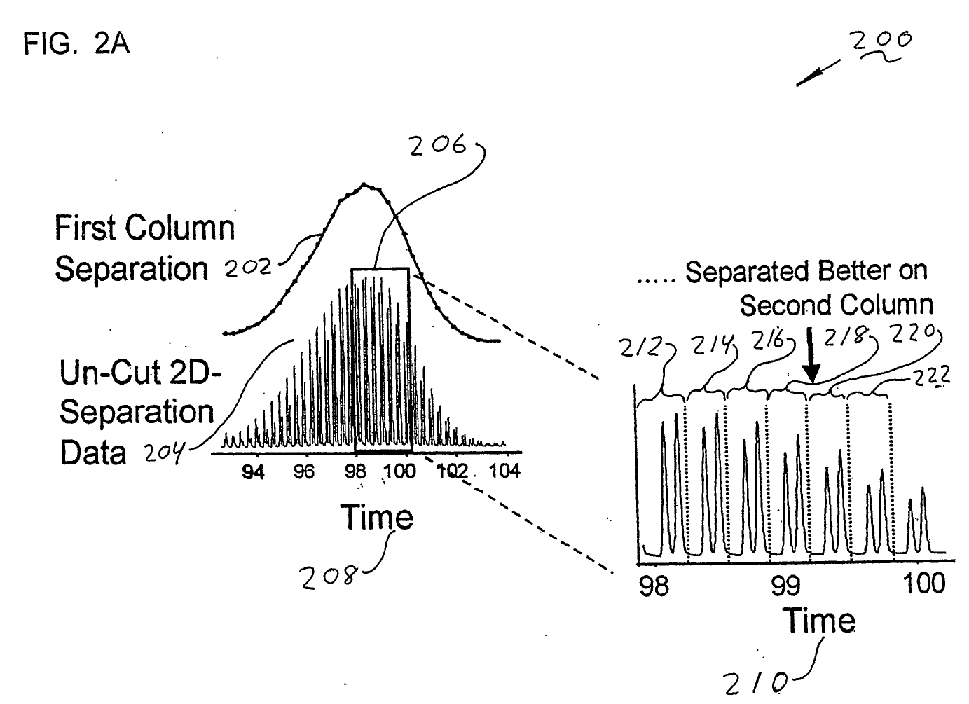

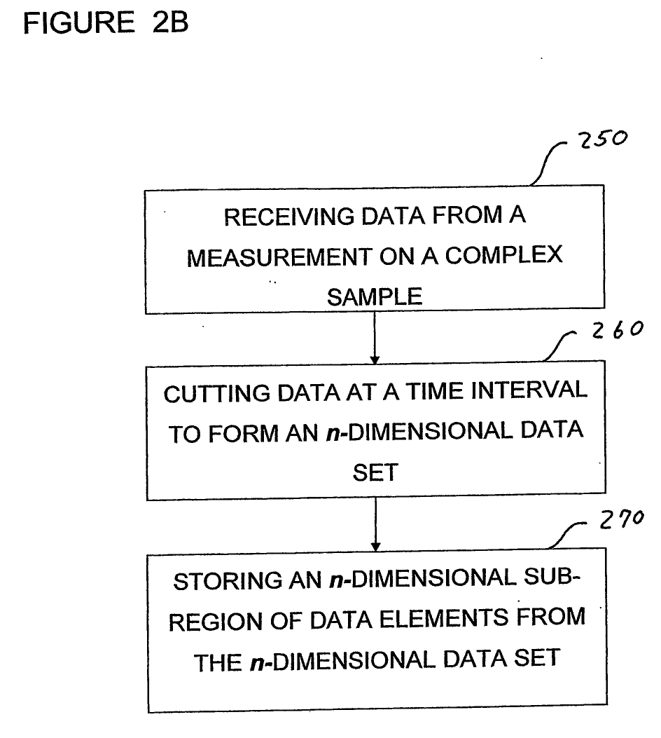

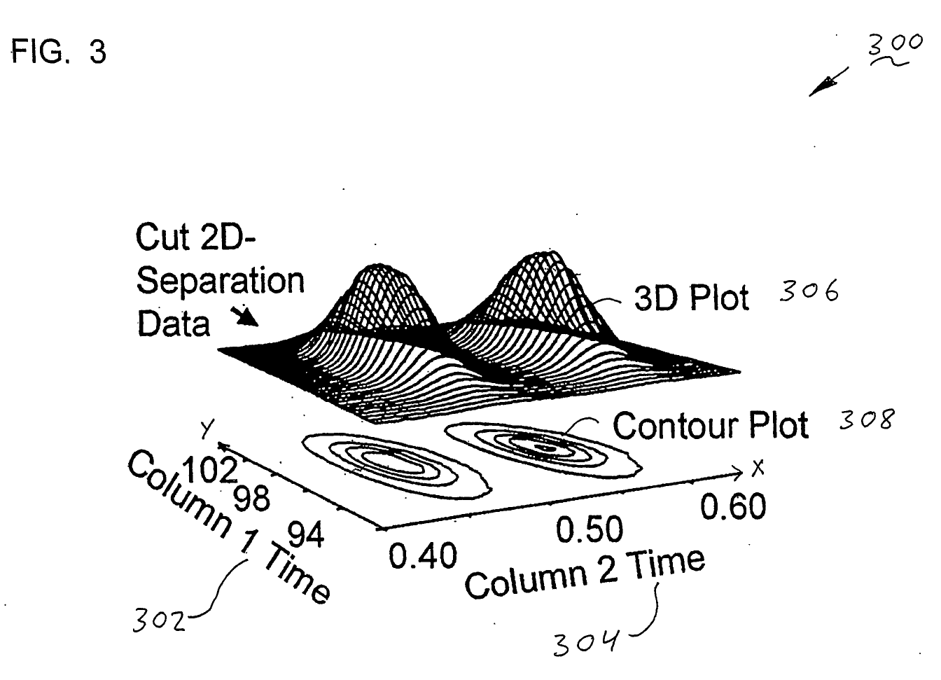

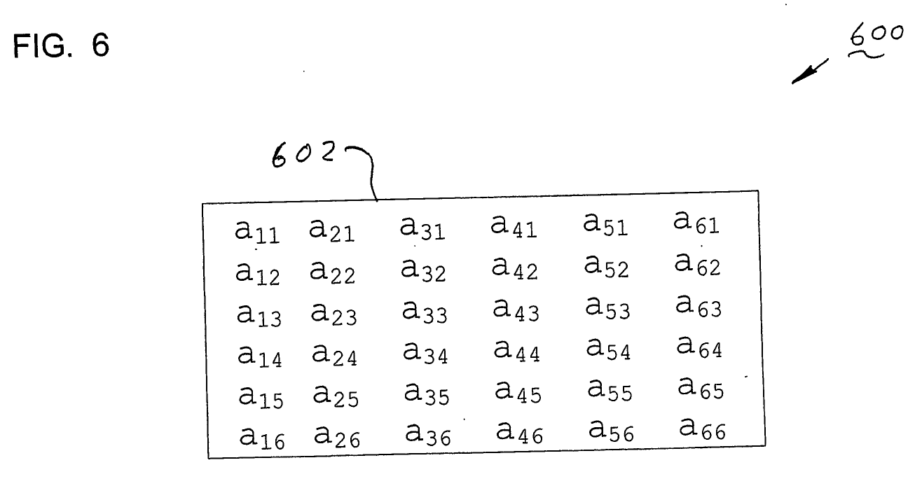

FIG. 2A illustrates generally at 200, processing hyphenated separations data according to one embodiment of the invention. FIG. 2B illustrates a process for creating an n-dimensional data set from a biological sample. With reference to FIG. 2A and FIG. 2B, the detector 112 (FIG. 1) has an output 204 recorded as a function of time 208 (FIG. 2A). The output 204 is the uncut two-dimensional separation data from the combined processes of the (GC×GC) system of FIG. 1. The timing of the secondary injector (the injection period) is used as a marker with which to cut the output 204 that is measured at the detector 112 (FIG. 1) to form a multidimensional data space (260 FIG. 2B). An envelope of the output 202 is shown at 202 verses absolute time 208 and represents separation of the sample due to the effects of the first column 106 (FIG. 1) on the sample. A window 206 is magnified to reveal six secondary injection periods 212, 214, 216, 218, 220, and 222. The data within these periods (amplitude and time referenced to the firing of the secondary injector are plotted sequentially as rows in an n-dimensional data set (matrix) displayed in FIG. 3 below and are stored as an p-dimensional sub-regions of data elements at 270 (FIG. 2B), which is described below in conjunction with FIG. 6 through FIG. 12C.

FIG. 3 illustrates visualization of two-dimensional separations data according to one embodiment of the invention generally at 300. With reference to FIG. 3, data collected over secondary injection periods 212, 214, 216, 218, 220, and 222 (FIG. 2A) are plotted as the rows of the n-dimensional data set (matrix). The X axis is labeled “Column 2 Time” at 304 which corresponds to data collected at the detector 112 (FIG. 1) over a series of successive periods of secondary injection. The Y axis is labeled “Column 1 Time” at 302 and corresponds to absolute time; the start of each secondary injection period (i.e., 212, 214, 216, 218, 220, and 222) is located in absolute time on the Y axis.

The result of such an assembly of data from a two-dimensional separation lends itself to visualization as indicated by the 3D plot 306 and the contour plot 308. Other methods of displaying amplitude can be used such as color modulation utilizing a color scale. The goal of comprehensive two-dimensional (2-D) separation methods such as the GC×GC described above or in other embodiments, liquid chromatography hyphenated with liquid chromatography (LC×LC), liquid chromatography hyphenated with capillary electrophoresis (LC×CE), CE×CE, etc., is to increase the separation space by simultaneously applying two columns with complementary separation mechanisms. Thereby, providing more information on the biological sample, and/or more information per unit time. Such multidimensional biological data sets are very large and exceed the addressable memory of many existing computers; thereby rendering much analysis of these complete data sets intractable. Methods and apparatuses that permit efficient storage and retrieval of such biological data sets will be described below in conjunction with FIG. 6 through FIG. 12C.

In various embodiments, test devices can be connected in series or parallel or series and parallel combinations to produce higher dimensionality to the biological data. In one or more embodiments multiple experiments can be used to create additional dimensions.

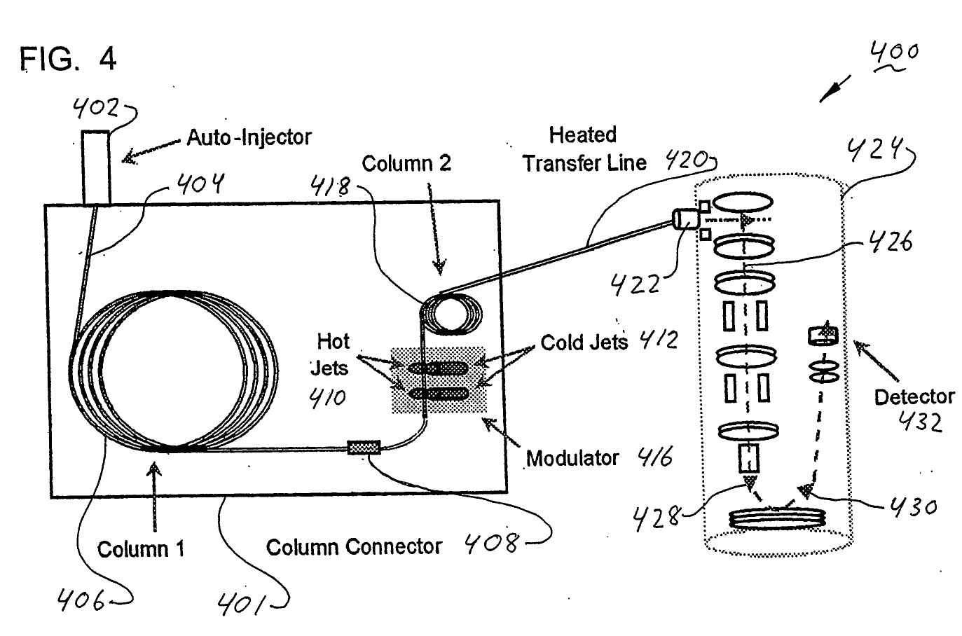

FIG. 4 shows generally at 400, one embodiment of a two-dimensional GC×GC separation system hyphenated with a time of flight mass spectrometer (GC×GC×TOFMS) according to one embodiment of the invention. With reference to FIG. 4, the GC×GC×TOFMS system provides more selectivity than the GC×GC system described above. A sample is injected by auto injector 402 into a tube 404 which feeds a first column 406. The temperature of the first column 406 is ramped causing less volatile substances to pass through the column at a faster rate. Effluent from the first column 406 passes through a column connector 408 and into a modulator 416. The modulator 416 injects the effluent onto the second column 418.

In the embodiment shown in FIG. 4, injection by the modulator 416 is accomplished by collection of the sample for approximately two seconds. The sample is frozen by the cold jets 412. In one embodiment, the sample is heated by the hot jets 410 for approximately one millisecond. Heating the sample for one millisecond causes the sample to be injected onto the second column 418. Many injections are occurring onto the second column 418 for every injection by the auto injector 402 onto the first column 406. Such subsequent separations cause increased resolution within the sample. Effluent migrates along the heated transfer line 420 and into port 422 of a mass spectrometer 424. Mass spectrometer 424 is a time of flight mass spectrometer. It will be appreciated by those of skill in the art that other devices can be substituted for the mass spectrometer 424 including other types of mass spectrometers, the present invention is not limited by the configuration of biological sample instrumentation configured for analyzing the sample.

Effluent leaves the port 422, is ionized within the mass spectrometer 424 and is accelerated across the device along path 428, 430 and is detected by a detector 432. A distribution of mass, within the sample analyzed is determined with the mass spectrometer. In one embodiment, the detector 432 records 500 measurements per second of the mass of the particles in the sample.

Biological data sets from samples processed through such a system, as shown in FIG. 4, are even larger than the data sets produced by the GC×GC system described earlier; thereby, creating an even larger data processing burden for addressable memory access schemes employed in existing computers.

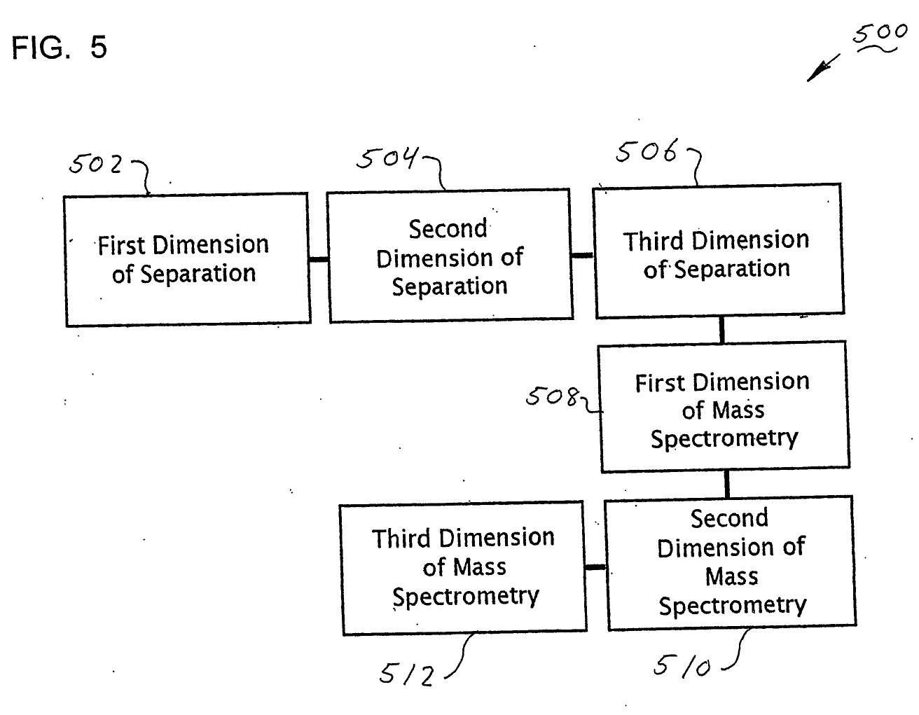

FIG. 5 illustrates a general multidimensional biological sample measurement system according to one embodiment of the invention, generally at 500. With reference to FIG. 5, a sample is injected into a first dimension of separation at 502. In various embodiments, the first dimension of separation 502 is a gas chromatography (GC) stage, in another embodiment 502 is a liquid chromatography stage (LC).

Effluent proceeds from 502 to a second dimension of separation at 504. In one embodiment, the second dimension of separation is a gas chromatography (GC) stage, in another embodiment 502 is a liquid chromatography stage (LC).

Effluent proceeds from 504 to a third dimension of separation at 506. In various embodiments, the third dimension of separation 506 is a gas chromatography (GC) stage, in another embodiment 506 is a liquid chromatography stage (LC).

Effluent proceeds from 506 into a first dimension of mass spectrometry at 508. Following the first dimension of mass spectrometry 508 the effluent proceeds into a second dimension of mass spectrometry at 510 and then into a third dimension of mass spectrometry at 512.

A detector (not shown) detects an output of the third dimension of mass spectrometry 512. In one embodiment, each stage of successive stage of processing (e.g., separation or mass spectrometry) injects a sample at a known time interval and each successive stage operates at in increased frequency relative to the previous stage. Data recorded from the detector is analyzed and correlated with known samples. Such analysis will be described below.

The separation instrument shown in FIG. 5 produces a six-dimensional biological data set. As the number of dimensions associated with a data set increases, the absolute size of a complete measurement on a sample necessarily increases, thereby increasing the burden on existing computers.

Embodiments of the present invention are configured to provide efficient computation on multidimensional biological sample measurements made by combining analytical units such as liquid chromatography (LC), gas chromatography (GC), capillary electrophoresis (CE), solid phase extraction, gel chromatography (gelC), open-bed chromatography (planar chromatography), mass spectrometers, etc. The present invention is not limited by the configuration of test apparatus.

For example, different types of LC test apparatus can be used, such as but not limited to, high performance liquid chromatography (HPLC), absorption chromatography, ion-exchange chromatography, normal phase chromatography, reverse phase chromatography, size exclusion chromatography, any device acting as a HPLC method, other LC methods of various types, and any device acting as a LC method.

Similarly, various types of gas chromatography (GC) methods can be used and any device acting as a GC method.

Various types of capillary electrophoresis (CE) methods can be used, such as but not limited to, capillary zone electrophoresis (CZE), capillary gel electrophoresis (CGE), capillary isoelectric focusing (CIEF), isotachophoresis (ITP), electrokinetic chromatography (EKC), micellar electrokinetic capillary chromatography (MECC OR MEKC), capillary electrochromatography (CEC), non-aqueous capillary electrophoresis (NACE), other CE methods of various types, any device acting as a CE method.

Various gel chromatography (gelC) methods can be used, such as but not limited to, one-dimensional gel methods, two-dimensional gel methods, any other gel methods, and any device acting as a method of gel chromatography.

Various open-bed chromatography (planar chromatography) can be used, such as but not limited to, thin layer chromatography (TLC), paper chromatography, other open-bed chromatography methods, and any device acting as an open-bed chromatography method.

Other chromatography methods can be used, such as but not limited to affinity chromatography, etc. Other analytical methods can be used, such as but not limited to, solid phase extraction.

Any type of mass spectrometer (MS) can be used, such as but not limited to time-of-flight (TOF), magnetic sector, quadrupole, ion trap, ion cyclotron resonance, Fourier transform ion cyclotron resonance (FTICR), etc. MS with electrospray ionization (ESI), matrix-assisted laser desorptionlionization (MALDI), surface enhanced laser desorption/ionization (SELDI), charge induced dissociation (CID), in source decay, or any other ionization method, MS combining any of the other analytical units above in series, in parallel, or in any other topology, other MS methods of various types, and any device acting as a MS.

Various detectors can be used to measure the sample, such as but not limited to, flame ionization detection (FID), thermal conductivity detection (TCD), electron capture detection (ECD), flame photometric (FPD), hall electrolytic conductivity, laser-induced fluorescence (LIF), ultraviolet (UV) transmission detectors, other transmission detectors, autoradiological imaging, visible or non-visible wavelength reflectivity imaging, with or without a stain, detectors of various types, and any device acting as a detector.

In various embodiments of the invention, biological data can be analyzed from; a system configured from a single analytical unit described above, a system configured from two or more analytical units described above arranged in series; a system configured from two or more analytical units of the same type; a system configured from two or more analytical units arranged in parallel or in a series parallel combination, a system configured from any of the systems mentioned above including any necessary injector, modulator, pressure or vacuum pump, valve, storage loop, reagent reservoirs, sumps, automated sample handling equipment, computer controls, communication or networking devices, power supplies, and any other device necessary to make a complete functional system to acquire multidimensional biological sample data.

Pattern recognition requires matrix math operations to be performed on the complete data sets. Such mathematical operations include, but are not limited to, principal component analysis, singular value decomposition, partial least squares, peak-finding, matrix multiplication, matrix inverse, determinant, Kronecker product, etc. It is often necessary to perform operations on the data, such as but not limited to aligning, re-sampling, averaging, noise suppression, de-convolution, peak-finding, etc.

As previously described the quantity of the data that results from such multidimensional analytical techniques requires an automated data processing system. However, currently available automated data processing systems, apart from specially configured super computers, are not capable of performing mathematical operations on data sets this large. For example, a current commercially available operating system, WINDOWS® XP, has an addressable memory limit of 2 gigabytes per process. Therefore, a computer running the WINDOWS® XP operating system cannot, using conventional techniques, perform mathematical operations (pattern recognition) on data sets exceeding 2 gigabytes that result from multidimensional biological sample measurements. Even with a large data set that does not exceed this limit, the conventional method of storing and accessing data is not efficient enough to make the computations practical.

FIG. 6 illustrates an array of biological data according to one embodiment of the invention, indicated generally at 600. In this example, array 602 is chosen to be a 6 by 6 array for simplicity of illustration; however, in practice, array 602 can have billions of elements, and many more than two dimensions. A conventional operating system is limited to storing the elements of array 602 in addressable memory. Depending on the computer language in use at the time the array 602 will be written to addressable memory by concatenating the rows together or the columns together, for the two dimensional case of array 602.

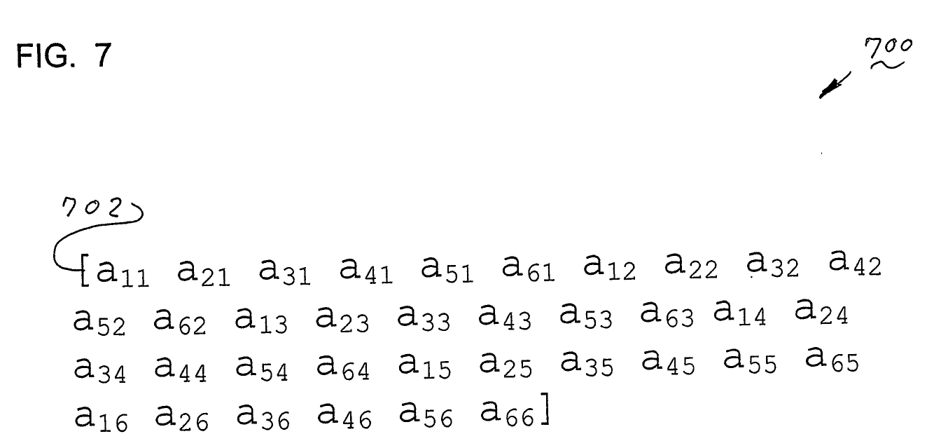

FIG. 7 depicts traditional storage of an array of biological data, generally at 700. With respect to FIG. 7, the array 602 (FIG. 6) is stored as a one-dimensional vector of concatenated rows at 702. In some computer architectures, the computer system will not be able to store the array 602 into addressable memory because the array 602 will exceed the addressable memory limit. In this description, addressable memory means the physical random access memory (RAM) and the maximum amount of virtual memory that can be addressed in conjunction with the physical RAM.

When the array 602 is large and is still capable of being stored in addressable memory the order of storage in addressable memory separates neighboring elements in the array 602 (FIG. 6). For example, a_{1,1}, a_{2,1}, and a_{1,2} are neighbors in the array 602; however, a_{1,1}, and a_{1,2} are relatively distant when stored in memory at 702. As an array becomes very large this relative distance between neighboring array elements in storage can become great enough to place neighboring data array elements on different memory pages. This results in computations between neighboring array elements becoming very inefficient; thereby taking an unduly long time. Mathematical operations on multidimensional data of the type required for pattern recognition or other desirable analysis of biological data require many operations on neighboring array elements and are therefore ill-suited to large sets of multidimensional data.

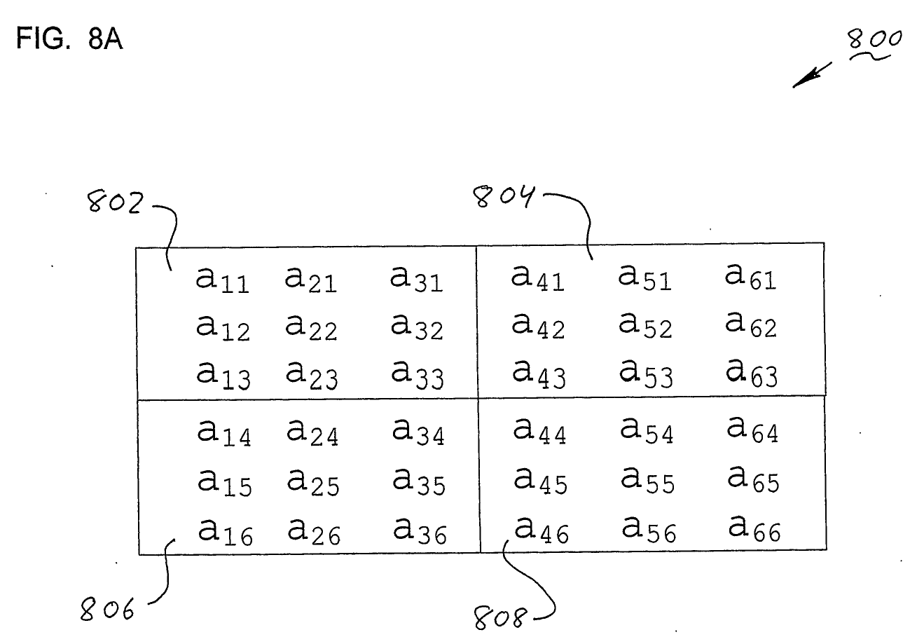

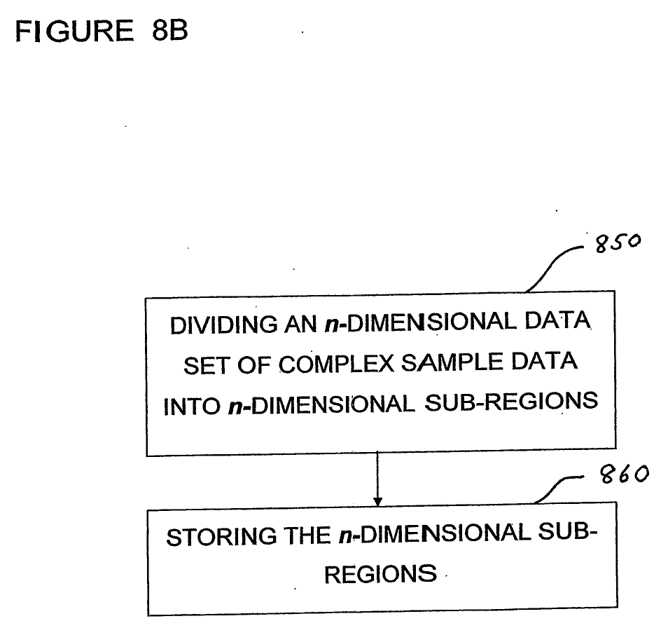

FIG. 8A shows one embodiment of a division of biological data into sub-regions or bricks, of n-dimensional size, and FIG. 8B illustrates a process for dividing an n-dimensional data set into n-dimensional sub-regions. With reference to FIG. 8A and FIG. 8B, the two dimensional array 602 (FIG. 6) is divided into four sub-regions 802, 804, 806, and 808. As mentioned earlier, the data elements within an actual biological data set can number into the billions or more, such arrays of data elements can exceed the addressable memory of any existing computer system. In embodiments of the present invention, efficient storage of arrays exceeding addressable memory is accomplished by dividing an array, such as the array at 800, into sub-regions (at 850 in FIG. 8B) and writing the data elements within a sub-region out to memory and/or disk storage (at 860 in FIG. 8B) sequentially and then proceeding to the next sub-region and so on until the entire array has been written to memory or disk storage. As used in this description of embodiments of the invention, “disk storage” is used to refer to data storage in a location other than the conventional “main” memory of the computer, such as RAM, cache, etc. In one embodiment, “disk storage” is an example of a large slow memory. The present invention is not limited to storing/retrieving data in/from a particular “memory” or storage device. Various embodiments of the invention can be employed to balance efficient storage and/or access of data among a plurality of storage locations, where the speeds of access among the storage locations can differ.

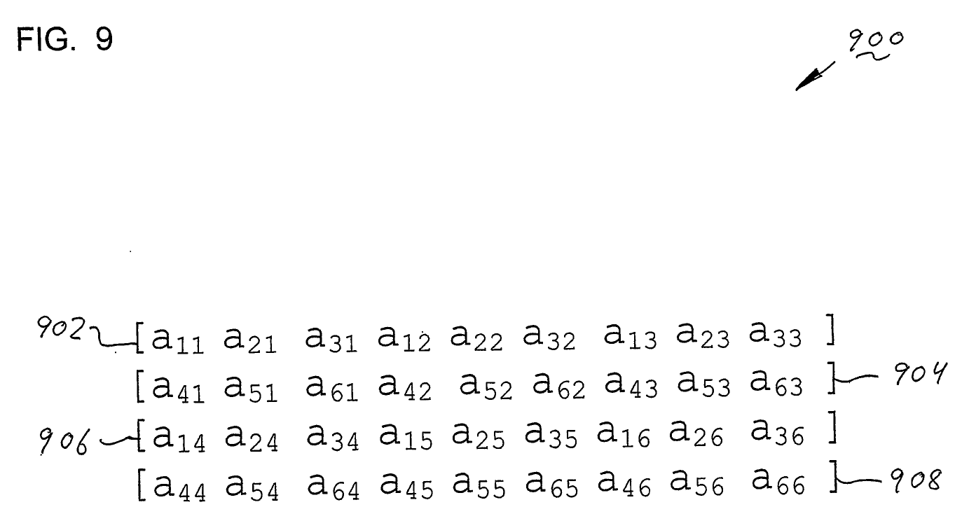

FIG. 9 illustrates one embodiment of storing sub-regions (bricks) of biological data generally at 900. With reference to FIG. 9, each sub-region from FIG. 8A (i.e., 802, 804, 806, and 808) is stored as a vector in either memory or disk storage. With the exception of neighboring data elements on either side of a sub-region boundary, neighbors are not distant in physical memory. From FIG. 9, a_{1,1} is now close to both a_{2,1} and a_{1,2}. The two elements a_{1,1} and a_{1,2} are now nearby in memory and, if a sub-region (brick) is the size of a memory page or smaller and sub-regions (bricks) are aligned on memory pages, the two elements are no longer at risk of being on separate memory pages (in a larger array) as they were when stored via the conventional storage scheme shown in FIG. 7. Those skilled in the art will appreciate that for operating systems which treat a sequential series of memory pages as a group, the critical size limit of a sub-region (brick) may be the size of the group of memory pages, rather than a size of an individual memory page. In the following discussion, “memory page, and “most efficient memory page” refers to a size of memory that an operating system generally handles as a group, and the specific size for which performance of the sub-region (brick) architecture is highest. There are seldom more than a few possible values for this size for any particular operating system. The correct value can be verified experimentally by comparing performance for each of the smaller number of values, but a correct value is usually described in the operating system documentation, even if the hardware is physically capable of supporting other (usually smaller) “memory page” sizes.

A data set of n-dimensions can be divided into sub-regions and stored in either memory or disk storage. In one embodiment, the length of a sub-region in a given dimension is constrained to be a power of 2. Sizing sub-regions to be a power of 2 allows division to be performed by bit shifting, which speeds access of a data element of the array from within the storage hierarchy. With conventional data storage, a data coordinate resolves into an address in virtual memory. Within the architecture described herein a data coordinate resolves to a sub-region (brick) number and offset into the sub-region. Under the architecture described herein, the overall size for data storage becomes equal to the available disk storage, which is typically orders of magnitude greater than the size of the maximum addressable memory.

In one embodiment, the sub-regions are sized to occupy a full page of memory. In one embodiment the dimensions of a sub-region are sized to minimize waste at the edges of the data space within a sub-region.

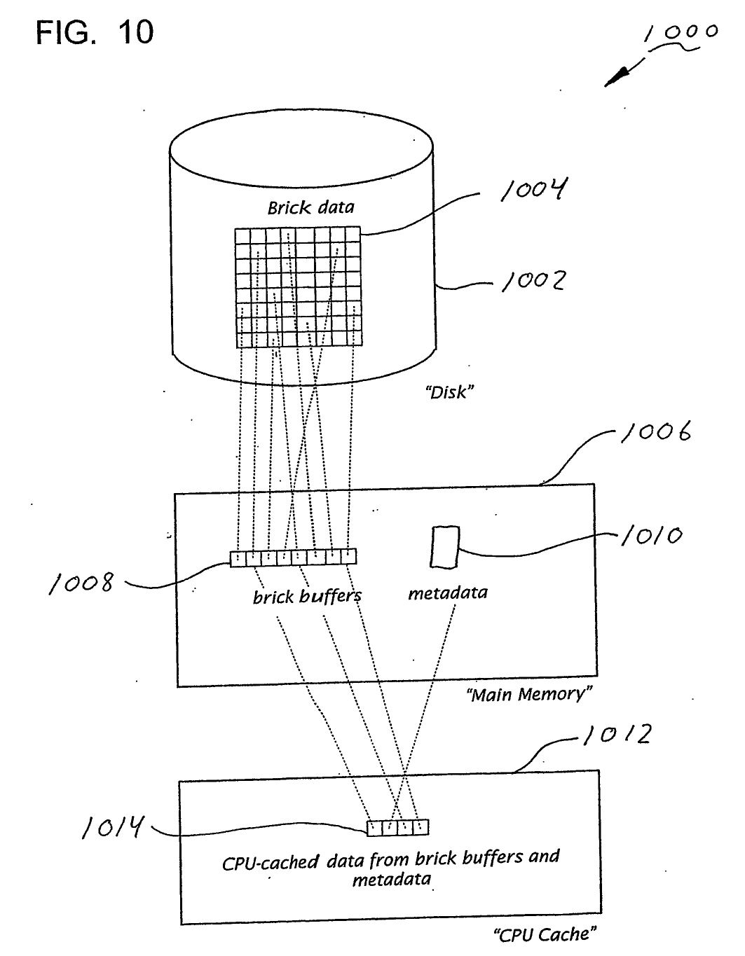

FIG. 10 illustrates a memory structure, and memory management method, shown generally at 1000, applied to sub-regions (bricks) of biological data according to one embodiment of the invention. With reference to FIG. 10, a collection of sub-regions making up the array of biological data elements is shown at 1004 within disk storage 1002. As mentioned earlier the two-dimensional case is presented herein; however, sub-regions can have any number of dimensions. The sub-regions typically have as many dimensions as is contained in the data set. Each sub-region represents a specific portion of the original data set. The sub-regions can be sparsely or densely populated with data elements, no limitation is implied thereby.

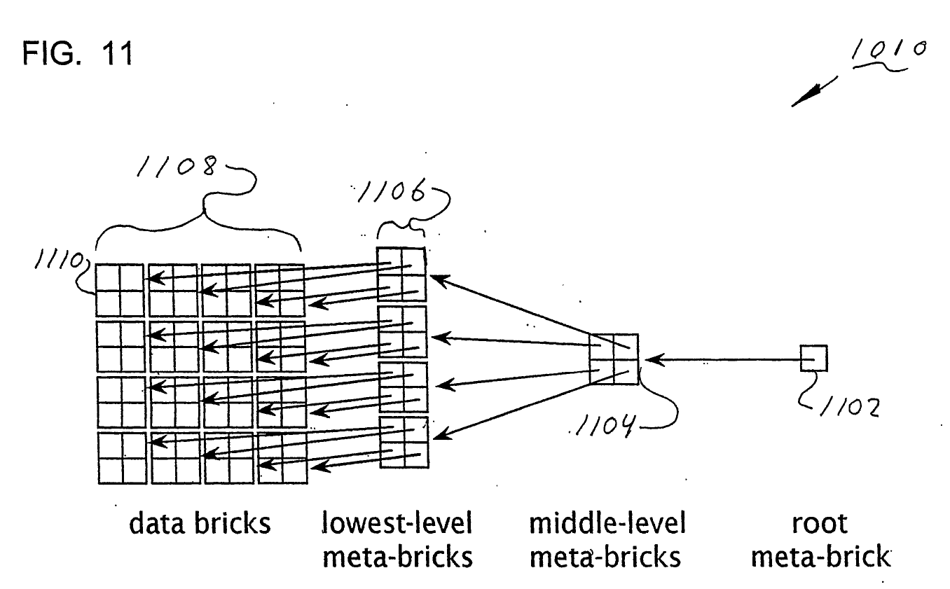

In one embodiment, a subset of sub-regions is maintained in RAM or similar large addressable memory 1006, functioning as a cache and indicated on FIG. 10 as brick buffers 1008. As required for analysis on sub-regions, during mathematical operations previously described, sub-regions are transferred to and from disk 1002 and addressable memory “main memory” 1006. Meta-data 1010 is also carried in addressable memory 1006. Meta-data will be described more completely below in conjunction with FIG. 11.

Data for the most recently used sub-regions (bricks) accumulates in the central processing unit (CPU) cache 1012 as indicated by 1014. Computations are concentrated in as few sub-regions as possible for maximum calculation efficiency by minimizing transfers of data in sub-regions to and from disk storage 1002. If a computer architecture provides multiple levels of CPU cache, then in one embodiment, sub-regions accumulate in all CPU cache levels, thereby allowing data to be loaded quickly.

FIG. 11 shows a relationship of meta-data and data sub-regions (bricks) according to one embodiment of the invention. Meta-data is recorded at various levels to allow fast searches through the data set when meta-data can constrain a search. In one embodiment, meta-data consists of the overall properties of the sub-region, such as the boundaries, and the maximum and minimum data values. In one embodiment, meta-data is maintained in the addressable memory 1006 (FIG. 10) for fast access speed since it can be used to avoid accessing the slower “very large memory” disk storage 1002 (FIG. 10) altogether in a constrained search. In one embodiment, metadata is cached in the CPU data cache 1012 at 1014 (FIG. 10) if the computation makes use of metadata.

With reference to FIG. 11, metadata 1010 is illustrated in more detail. Three layers of metadata are shown; however, there can be a general number of layers of metadata. The sub-regions 1108 of the data set are illustrated as two-dimensional; however, as previously described the sub-regions, like the data set, can be multidimensional and in general of size n. For illustration, a root meta-brick contains information on meta-bricks at the lower levels. Each meta-brick at a middle-level 1104 contains metadata for four lowest-level meta-bricks 1106, and each lowest level meta-brick 1106 contains information on four sub-regions (data bricks), such as 1110. In various embodiments of the invention, the meta-bricks 1104 can contain metadata on more than four meta-bricks 1106 and the meta-bricks 1106 can contain metadata on more than four sub-regions (data bricks) 1108. The hierarchical tree, shown in FIG. 11, permits searching within a given range to be performed by only traversing the branches of the tree whose metadata indicates that data exists within the desired range. Such a structure prevents needless reads from storage and greatly speeds the search.

In one embodiment, which can be used with the C++ programming language, an n-dimensional array of biological data elements is represented by an object, such as a cND_Matrix. Those of skill in the art will appreciate that a “class” or a “memory structure” can be substituted for “object” in the previous sentence. The cND_Matrix includes a plurality of items, such as a cPagedDiskFile, a tree of cMetaBricks, and a list of cLeafBricks (the cLeafBricks form the leaves of the tree of cMetaBricks).

In one embodiment, a cPagedDiskFile embodies the following functionality, such as; a set of buffers for swapping pages of sub-region (brick) array data, from the n-dimensional array of biological data elements, to and/or from storage; tracking which sub-region (brick) data pages are currently swapped into which buffers; tracking buffer aging, so that least recently used buffers are swapped out first; locking selected buffers, so that the sub-region (brick) data pages therein are not subject to swapping; and one or more file handles for reading and writing pages of sub-region (brick) data to and/or from storage as needed. Multiple file handles may be needed if operating system restrictions limit the length of a file to less than the total size needed to represent the cND_Matrix.

In one embodiment, a cLeafBrick includes a plurality of items, such as: a page number, which the cPagedDiskFile component can use to save or store the sub-region's (brick's) array data to and/or from storage; metadata, which can include minimum and/or maximum values of the biological sample data elements within the sub-region (brick), minimum and/or maximum peak values and a list of peaks if peak-finding was performed, and the n-dimensional boundaries of the sub-region (brick); a pointer to the cLeafBrick's parent cMetaBrick in the tree of cMetaBricks.

In one embodiment, a cMetaBrick includes: metadata, which can include minimum and/or maximum values of the biological data elements for all sub-regions (bricks) below the cMetaBrick in the tree of cMetaBricks; minimum and/or maximum peak values for all sub-regions (bricks) below the cMetaBrick if peak-finding had been performed on the data; the n-dimensional boundaries of all the sub-regions (bricks) below the cMetaBrick; and a pointer to the cMetaBrick's parent cMetaBrick in the cMetaBrick tree.

Such an architecture, of the cND_Matrix, enables swapping to be controlled and optimized along with the ability to search the data contained therein. In one or more embodiments, a cND_Iterator component traverses an n-dimensional data set (matrix), such as a cND_Matrix, sub-region by sub-region, instead of by the traditional row, column, etc. order. Data elements are accessed in sub-region (brick) order. Each data value in a sub-region (brick) is visited before moving on to the next sub-region (brick); thereby minimizing page swaps. The cND_Iterator can also instruct a cND_Matrix's cPagedDiskFile to lock the current sub-region's (brick's) page in memory so that unwanted swaps are eliminated.

In various embodiments, matrix math routines such as multiplication, Kronecker product, etc. are customized to accommodate traversing a n-dimensional data set (matrix) by sub-region (brick) order rather than traditional row, column, etc. order. Traversal of an n-dimensional data set (matrix) by sub-region order can enable mathematical operations to be performed on matrices that would otherwise exceed the size of addressable storage of a data processing system.

A set of data coordinates within a given n-dimensional data set (matrix) corresponds to a particular data value, these data coordinates are mapped to a particular sub-region (brick). The particular sub-region (brick) that contains the particular data value can be calculated from; the dimensions of the n-dimensional data set (matrix) and the dimensions of the sub-regions (bricks).

In one embodiment, directed to an n-dimensional data set where n=3, a data value V, has coordinates (x, y, z) within the n-dimensional data set, referred to in this example as a matrix M, where the matrix M has a size (i, j, k). The dimensions of the sub-regions (bricks), which make up the matrix M are (a, b, c). The number of sub-regions (bricks) (A, B, C) in each dimension are found from: A=i/a, B=j/b, and C=k/c. The sub-region (brick) location (X, Y, Z) that corresponds to the data value V is found from: X=x/a, Y=y/b, and Z=z/c. The number of the (X, Y, Z) sub-region's (brick's) data page is determined to be: X*B*C+Y*B+C.

The offsets (offset_i, offset_j, offset_k) into the (X, Y, Z) sub-region corresponding to the data value V can be found from the following equations: offset_i=i−X*a; offset_j=j−Y*b; and offset_k=k−Z*c. Those knowledgeable in the art will understand that the offsets (offset_i, offset_j, offset_k) can be represented in a variety of ways, the equations given above are one example, and that no limitation is implied thereby.

At times it may be desirable to provide an increase in computational speed for the divide operations described above, such as: x/a, y/b, z/c, etc. As mentioned above, in one or more embodiments, an enhancement in computational speed can be achieved by selecting values for a, b, and c that are powers of two (2), in such a case division can be replaced with bit shifting. Constraining a, b, and c to be powers of two can create unused space in a matrix that contains the sub-regions (bricks).

Intelligent selection of values for a, b, and c can be done to balance the need for computational efficiency and efficient storage. The total storage space required for a matrix having (A, B, C) sub-regions and (a, b, c) sub-region dimensions is: A*a*B*b*C*c, which should equal i*j*k for peak efficiency. It will be noted that the goal of the sub-regions is to create neighborhoods of data such that traversal in any given dimension is no more likely to cross a memory page boundary than traversal in any other dimension. Thus, it is undesirable to create sub-regions (bricks) where the value of any of a, b, or c is very small relative to the other dimensions. However, selection of (a, b, c) creating a sub-region with approximately equal dimensions may lead to some wasted memory.

In one embodiment, an n-dimensional array sized (6, 1000, 2000) contains twelve million (12,000,000) data values. If these data values are represented as 4 byte floating point values and the operating system's most efficient memory page size is 16 kilobytes, then a matrix with at least 2,930 sub-regions is needed for storage. It will be noted that for this example, no combination of powers of two for the sub-region size (a, b, c) exists such that a*b*c=2,930. Therefore, some unused storage space is inevitable, which means that some of the sub-regions (bricks) will not be fully utilized, resulting in some wasted memory.

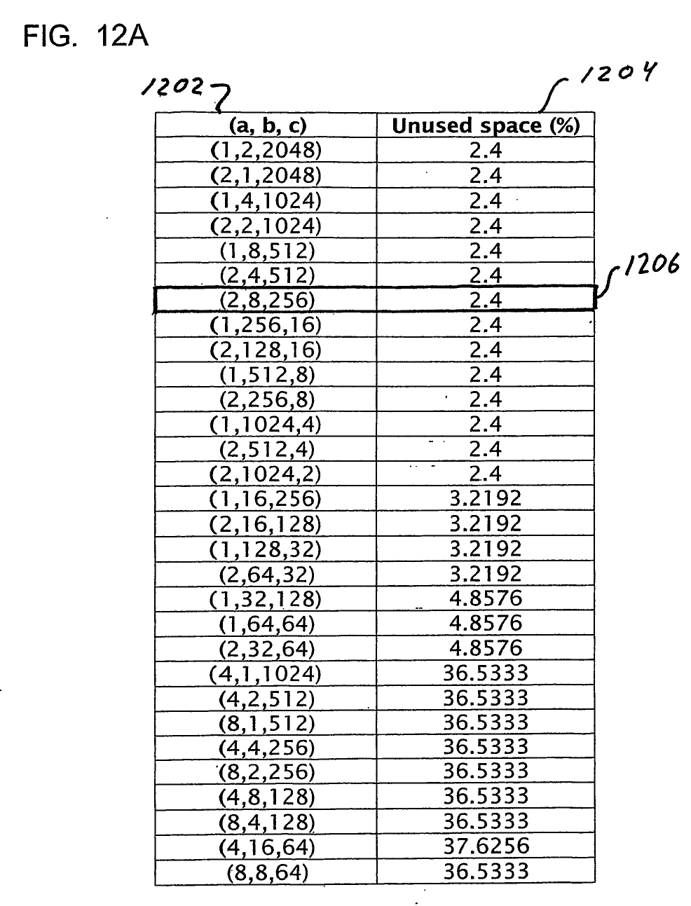

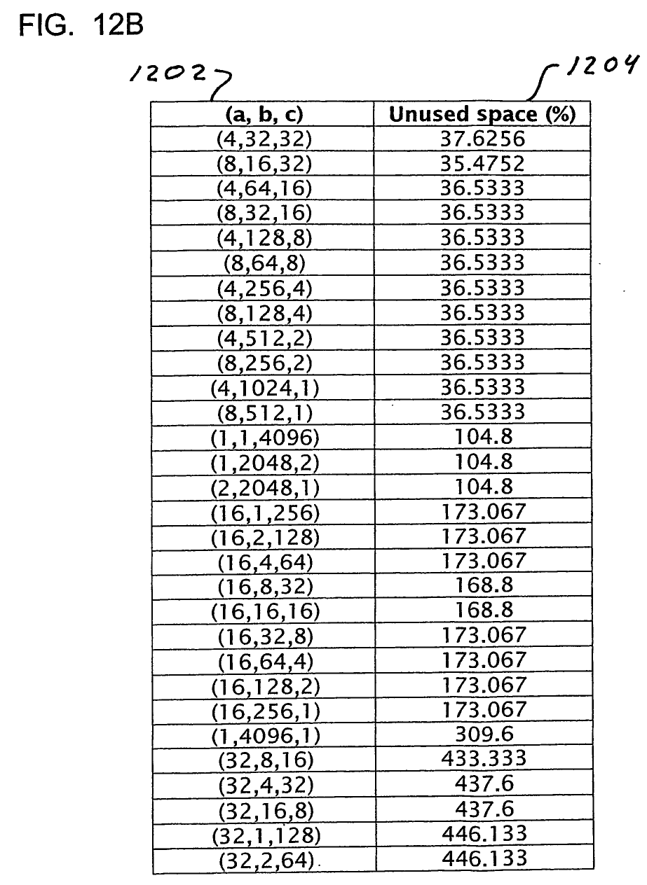

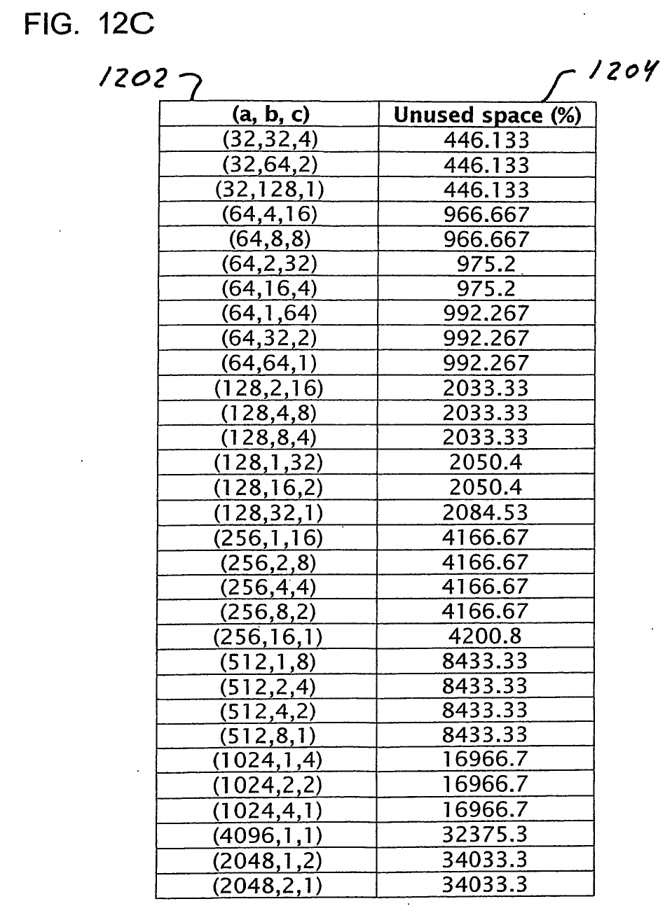

FIG. 12A through FIG. 12C illustrate possible combinations of sub-region dimensions (a, b, c) at 1202 and the resulting unused space within the matrix, expressed as a percentage of used space, is listed at 1204. In some embodiments, it is desirable to use a sub-region size that provides low unused space, is somewhat uniform in all dimensions, and is weighted toward the higher order dimensions, since the higher order dimensions are generally cycled through more frequently than the lower order dimensions in many types of analysis, such as analysis directed toward pattern recognition of biological samples. In the example presented, the best choice for some analyses is found in FIG. 12A at 1206, where (a, b, c)=(2, 8, 256), such that (A, B, C)=(3, 125, 8). Unused storage space, expressed as a percentage of used space is at 2.4% in this example.

The size of the n-dimensional array was selected for convenience of illustration, in the example above. It will be appreciated that n-dimensional arrays can exceed the size of addressable storage and the techniques described above can be employed to facilitate storing and reading such large data sets; thereby, enabling mathematical operations to performed thereon. Thus, utilizing various embodiments of the invention, pattern recognition is enabled on large data sets that cannot be loaded into a conventional addressable memory of a data processing system.

For purposes of discussing and understanding the embodiments of the invention, it is to be understood that various terms are used by those knowledgeable in the art to describe techniques and approaches. Furthermore, in the description, for purposes of explanation, numerous specific details are set forth in order to provide a thorough understanding of the present invention. It will be evident, however, to one of ordinary skill in the art that the present invention may be practiced without these specific details. In some instances, well-known structures and devices are shown in block diagram form, rather than in detail, in order to avoid obscuring the present invention. These embodiments are described in sufficient detail to enable those of ordinary skill in the art to practice the invention, and it is to be understood that other embodiments may be utilized and that logical, mechanical, electrical, and other changes may be made without departing from the scope of the present invention.

Some portions of the description may be presented in terms of algorithms and symbolic representations of operations on, for example, data bits within a computer memory. These algorithmic descriptions and representations are the means used by those of ordinary skill in the data processing arts to most effectively convey the substance of their work to others of ordinary skill in the art. An algorithm is here, and generally, conceived to be a self-consistent sequence of acts leading to a desired result. The acts are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the discussion, it is appreciated that throughout the description, discussions utilizing terms such as “processing” or “computing” or “calculating” or “determining” or “displaying” or the like, can refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission, or display devices.

An apparatus for performing the operations herein can implement the present invention. This apparatus may be specially constructed for the required purposes, or it may comprise a general-purpose computer, selectively activated or reconfigured by a computer program stored in the computer. Such a computer program may be stored in a computer readable storage medium, such as, but not limited to, any type of disk including floppy disks, hard disks, optical disks, compact disk-read only memories (CD-ROMs), and magnetic-optical disks, read-only memories (ROMs), random access memories (RAMs), electrically programmable read-only memories (EPROM)s, electrically erasable programmable read-only memories (EEPROMs), FLASH memories, magnetic or optical cards, etc., or any type of media suitable for storing electronic instructions either local to the computer or remote to the computer.

The algorithms and displays presented herein are not inherently related to any particular computer or other apparatus. Various general-purpose systems may be used with programs in accordance with the teachings herein, or it may prove convenient to construct more specialized apparatus to perform the required method. For example, any of the methods according to the present invention can be implemented in hard-wired circuitry, by programming a general-purpose processor, or by any combination of hardware and software. One of ordinary skill in the art will immediately appreciate that the invention can be practiced with computer system configurations other than those described, including hand-held devices, multiprocessor systems, microprocessor-based or programmable consumer electronics, digital signal processing (DSP) devices, set top boxes, network PCs, minicomputers, mainframe computers, and the like. The invention can also be practiced in distributed computing environments where tasks are performed by remote processing devices that are linked through a communications network.

The methods of the invention may be implemented using computer software. If written in a programming language conforming to a recognized standard, sequences of instructions designed to implement the methods can be compiled for execution on a variety of hardware platforms and for interface to a variety of operating systems. In addition, the present invention is not described with reference to any particular programming language. It will be appreciated that a variety of programming languages may be used to implement the teachings of the invention as described herein. Furthermore, it is common in the art to speak of software, in one form or another (e.g., program, procedure, application, driver, . . . ), as taking an action or causing a result. Such expressions are merely a shorthand way of saying that execution of the software by a computer causes the processor of the computer to perform an action or produce a result.

It is to be understood that various terms and techniques are used by those knowledgeable in the art to describe communications, protocols, applications, implementations, mechanisms, etc. One such technique is the description of an implementation of a technique in terms of an algorithm or mathematical expression. That is, while the technique may be, for example, implemented as executing code on a computer, the expression of that technique may be more aptly and succinctly conveyed and communicated as a formula, algorithm, or mathematical expression. Thus, one of ordinary skill in the art would recognize a block denoting A+B=C as an additive function whose implementation in hardware and/or software would take two inputs (A and B) and produce a summation output (C). Thus, the use of formula, algorithm, or mathematical expression as descriptions is to be understood as having a physical embodiment in at least hardware and/or software (such as a computer system in which the techniques of the present invention may be practiced as well as implemented as an embodiment).

A machine-readable medium is understood to include any mechanism for storing or transmitting information in a form readable by a machine (e.g., a computer). For example, a machine-readable medium includes read only memory (ROM); random access memory (RAM); magnetic disk storage media; optical storage media; flash memory devices; electrical, optical, acoustical or other form of propagated signals (e.g., carrier waves, infrared signals, digital signals, etc.); etc.

As used in this description, “one embodiment” or “an embodiment” or similar phrases mean that the feature(s) being described are included in at least one embodiment of the invention. References to “one embodiment” in this description do not necessarily refer to the same embodiment; however, neither are such embodiments mutually exclusive. Nor does “one embodiment” imply that there is but a single embodiment of the invention. For example, a feature, structure, act, etc. described in “one embodiment” may also be included in other embodiments. Thus, the invention may include a variety of combinations and/or integrations of the embodiments described herein.

While the invention has been described in terms of several embodiments, those of skill in the art will recognize that the invention is not limited to the embodiments described, but can be practiced with modification and alteration within the spirit and scope of the appended claims. The description is thus to be regarded as illustrative instead of limiting.

What is claimed is:

1. A method comprising:
receiving data from a measurement on a biological sample;
cutting data at, at least one time interval;
aligning data based on the cutting to form an n-dimensional data set; and
storing an n-dimensional sub-region of data elements from the n-dimensional data set, wherein a size of a dimension of the n-dimensional sub-region is less than a size of the dimension of the n-dimensional data set.

2. The method of claim 1, wherein the n-dimensional data set exceeds an addressable memory limit for a data processing system.

3. A method comprising:
dividing an n-dimensional data set into n-dimensional sub-regions, wherein a size of a dimension of an n-dimensional sub-region is less than a size of the dimension of the n-dimensional data set, the n-dimensional data set is obtained from a measurement made on a biological sample; and
storing the n-dimensional sub-regions on a computer readable medium, the computer readable medium is accessible to a data processing system.

4. The method of claim 3, wherein the n-dimensional data set exceeds an addressable memory limit for the data processing system.

5. The method of claim 3, wherein a size of the n-dimensional sub-region is set equal to a size of one page of memory.

6. The method of claim 3, wherein a size of each dimension of the n-dimensional sub-region is a power of two.

7. The method of claim 6, further comprising;
choosing the size of each dimension to balance uniformity in all dimensions against wasted storage space.

8. The method of claim 7, wherein a size of a dimension that will be traversed most rapidly during an analysis is increased relative to the size of the other dimensions.

9. The method of claim 6, wherein the size of each dimension is chosen to avoid excessive wasted memory while also minimizing page swapping.

10. The method of claim 9, wherein the largest dimension is chosen to be the dimension that is traversed most rapidly during an analysis.

11. The method of claim 3, wherein a detection is used to measure the property and the detection is selected from the group consisting of flame ionization detection (FID), thermal conductivity detection (TCD), electron capture detection (ECD), flame photometric detection (FPD), hall electrolytic conductivity detection, laser-induced fluorescence (LIF) detection, ultraviolet (UV) transmission detection, a transmission detection, autoradiological imaging detection, visible wavelength reflectivity imaging with a stain detection, visible wavelength reflectivity imaging without a stain detection, non-visible wavelength reflectivity imaging with a stain detection, and non-visible wavelength reflectivity imaging without a stain detection.

12. The method of claim 3, wherein the measurement is obtained with an analytical unit.

13. The method of claim 12, wherein the analytical unit is selected from the group consisting of liquid chromatography (LC), gas chromatography (GC), capillary electrophoresis (CE), solid phase extraction, gel chromatography (gelC), open-bed chromatography (planar chromatography), high performance liquid chromatography (HPLC), absorption chromatography, ion-exchange chromatography, normal phase chromatography, reverse phase chromatography, size exclusion chromatography, capillary electrophoresis (CE), capillary zone electrophoresis (CZE), capillary gel electrophoresis (CGE), capillary isoelectric focusing (CIEF), isotachophoresis (ITP), electrokinetic chromatography (EKC), micellar electrokinetic capillary chromatography (MECC OR MEKC), capillary electrochromatography (CEC), non-aqueous capillary electrophoresis (NACE), gel chromatography (GC), a one-dimensional gel method, a two-dimensional gel method, a device acting as a method of gel chromatography, thin layer chromatography (TLC), paper chromatography, affinity chromatography, mass spectrometer, time-of-flight (TOF) mass spectrometer, magnetic sector mass spectrometer, quadrupole mass spectrometer, ion trap mass spectrometer, ion cyclotron resonance mass spectrometer, Fourier transform ion cyclotron resonance (FTICR) mass spectrometer, mass spectrometer with electrospray ionization (ESI), matrix-assisted laser desorption/ionization (MALDI) mass spectrometer, surface enhanced laser desorption/ionization (SELDI) mass spectrometer, charge induced dissociation (CID) mass spectrometer, and in source decay mass spectrometer.

14. The method of claim 3, wherein the measurement is obtained by combining a plurality of analytical units.

15. The method of claim 14, wherein at least one of the plurality of analytical units is a capillary electrophoresis process.

16. The method of claim 14, wherein at least one of the plurality of analytical units is a means for performing capillary electrophoresis.

17. The method of claim 14, wherein at least one of the plurality of analytical units is a chromatography process.

18. The method of claim 14, wherein at least one of the plurality of analytical units is a means for performing chromatography.

19. The method of claim 14, wherein at least one of the plurality of analytical units is a mass spectroscopy process.

20. The method of claim 14, wherein at least one of the plurality of analytical units is a means for performing mass spectroscopy.

21. The method of claim 3, further comprising:
swapping a second n-dimensional sub-region with a first n-dimensional sub-region; and
utilizing the second n-dimensional sub-region in a mathematical operation.

22. The method of claim 21, further comprising;
traversing through the n-dimensional data set in sub-region order.

23. The method of claim 22, wherein the traversing is used in a mathematical operation that performs pattern recognition on the n-dimensional data set.

24. The method of claim 21, wherein the mathematical operation is used to identify a protein associated with the biological sample.

25. The method of claim 21, wherein the mathematical operation is used during an analysis of a biological sample and a process used during the analysis is selected from the group consisting of aligning, re-sampling, averaging, noise suppression, de-convolution, and peak-finding.

26. The method of claim 3, further comprising:
using metadata to search for a data element from the n-dimensional sub-regions, wherein the metadata enables the search to be performed on a subset of the n-dimensional sub-regions.

27. The method of claim 26, further comprising:
retrieving the data element based on the using.

28. A computer readable medium having stored thereon a data structure comprising:
a first field containing data representing a data value of an n-dimensional array, wherein the data value corresponds to a measurement made on a biological sample;
a second field containing data representing an n-dimensional sub-region number, the data value is assigned to the n-dimensional sub-region number; and
a third field containing data representing an offset into the n-dimensional sub-region number that corresponds to a location of the data value.

29. The computer readable medium of claim 28, further comprising;
a fourth field containing meta-data.

30. The computer readable medium of claim 29, wherein the meta-data provides information on a property of the n-dimensional sub-region.

31. The computer readable medium of claim 30, wherein the property is selected from the group consisting of a boundary, a maximum data value, a minimum data value, and a peak in the data.

32. A method comprising:
reading an n-dimensional data set, the n-dimensional data set represents a measurement of a property of a biological sample and the n-dimensional data set exceeds an amount of addressable storage associated with a data processing system;
dividing the n-dimensional data set into n-dimensional sub-regions, where a size of a dimension of an n-dimensional sub-region is less than a size of the dimension of the n-dimensional data set;
storing the n-dimensional sub-regions; and
performing mathematical operations on the n-dimensional sub-regions, wherein pattern recognition is applied to the n-dimensional data set through the performing.

33. The method of claim 32, wherein the measurement is obtained by combining at least two analytical units.

34. The method of claim 32, wherein a size of the n-dimensional sub-region is set equal to a size of one page of memory.

35. The method of claim 32, wherein a size of each dimension of the n-dimensional sub-region is a power of two.

36. An apparatus comprising:
an analytical unit, the analytical unit is configured to make a measurement of a property of a biological sample, wherein an n-dimensional data set is obtained from the measurement;
a storage device; and
a processor programmed to:
divide the n-dimensional data set into a plurality of n-dimensional sub-regions, wherein a size of a dimension of an n-dimensional sub-region is less than a size of the dimension of the n-dimensional data set; and
maintain in the storage device the plurality of n-dimensional sub-regions.

37. The apparatus of claim 36, further comprising:
a prepended analytical unit, the prepended analytical unit is in communication with the analytical unit and the biological sample passes from the prepended analytical unit into the analytical unit, wherein the apparatus is configured to measure a property of the biological sample.

38. The apparatus of claim 37, wherein the property is selected from the group consisting of a mass spectrum, an electric current, and a general property.

39. The apparatus of claim 36, wherein a first dimension of the n-dimensional data is set is obtained by cutting an output of the analytical unit at a time interval into segments and then aligning the segments of the output to form a first dimension of the n-dimensional data set.

40. The apparatus of claim 36, wherein the measurement is obtained by combining a plurality of analytical units.

41. The apparatus of claim 40, wherein at least two of the plurality of analytical units is combined in series.

42. The apparatus of claim 40, wherein at least two of the plurality of analytical units is combined in parallel.

43. The apparatus of claim 36, wherein the n-dimensional data set exceeds the processor's addressable memory limit and the processor is further programmed to:
perform mathematical operations on the n-dimensional data set by accessing data from the n-dimensional sub-regions.

44. The apparatus of claim 43, wherein a protein contained in the biological sample is identified.

45. The apparatus of claim 43, wherein pattern recognition is performed on the n-dimensional data set.

46. A computer readable medium containing executable computer program instructions, which when executed by a data processing system, cause the data processing system to perform a method comprising:
dividing an n-dimensional data set into n-dimensional sub-regions, wherein a size of a dimension of an n-dimensional sub-region is less than a size of the dimension of the n-dimensional data set, the n-dimensional data set is obtained from a measurement made on a biological sample; and
storing the n-dimensional sub-regions on a computer readable medium, the computer readable medium accessible to a data processing system.

47. The computer readable medium, as set forth in claim 46, wherein the n-dimensional data set exceeds an addressable memory limit for the data processing system.

48. The computer readable medium, as set forth in claim 46, the method further comprising:
swapping a second n-dimensional sub-region with a first n-dimensional sub-region; and
utilizing the second n-dimensional sub-region in a mathematical operation.

49. The computer readable medium, as set forth in claim 48, the method further comprising:
traversing through the n-dimensional data set in sub-region order.

50. The computer readable medium, as set forth in claim 48, wherein the mathematical operation is used to identify a protein associated with the biological sample.

51. An apparatus comprising:
means for storing an n-dimensional data set, wherein the n-dimensional data set represents a measurement of a property of a biological sample;
means for performing mathematical operations on the n-dimensional data set when the n-dimensional data set exceeds an addressable memory limit of a data processing system.

52. The apparatus of claim 51, further comprising:
means for measuring the property of the biological sample.

53. The apparatus of claim 51, wherein the mathematical operations are used to apply pattern recognition to the biological sample.
